(19) United States
(12) Patent Application Publication
(10) Pub. No.: US 2026/0267832 A1
(43) Pub. Date: Sep. 10, 2026

(54) METHOD AND SYSTEM FOR PERFORMING DATA MIGRATION

(71) Applicant: JPMorgan Chase Bank, N.A., New York, NY (US)

(72) Inventors: Soumyadip DAS, Bangalore (IN); Nagharajan RAGHAVENDRAN, East Brunswick, NJ (US)

(73) Assignee: JPMorgan Chase Bank, N.A., New York, NY (US)

(21) Appl. No.: 19/555,135

(22) Filed: Mar. 3, 2026

(30) Foreign Application Priority Data
Mar. 4, 2025 (IN) 202511019060

(51) Int. Cl. G06F 16/21; G06F 16/22

(52) U.S. Cl. CPC G06F 16/214; G06F 16/211; G06F 16/2282

(57) ABSTRACT

A method and a system for performing data migration are provided. The method includes: receiving a user prompt and an upload file; selecting a core processing unit from among a plurality of processing models; converting, via a data parser, the upload file into first metadata having a file format based on the user prompt; identifying schema information from the first metadata; storing the schema information in a metadata hub; aligning, via the core processing unit, the schema information into a tabular format based on the user prompt; analyzing, via the core processing unit, the aligned schema information to identify whether at least one from among a missing field and a duplicated field exist; and generating an output including the aligned schema information and a result of the analyzing.

### CROSS-REFERENCE TO RELATED APPLICATIONS

This application claims priority benefit from Indian Application No. 202511019060, filed on Mar. 4, 2025, in the U.S. Patent and Trademark Office, which is hereby incorporated by reference in its entirety.

### FIELD OF THE DISCLOSURE

This technology generally relates to methods and systems for performing data migration, and more particularly to methods and systems for comparing source data with user-required fields and columns to perform precise matching of data and column names to migrate data into a predetermined format.

### BACKGROUND INFORMATION

Many companies and businesses have to deal with the navigation of multiple migrations, decommissioning efforts, and exits. This period of extensive development modernization has made it increasingly challenging for developers to source data from new systems, often leading to errors and typos, and requiring an extensive amount of time.

Traditional methods of sourcing data present significant challenges for data teams, leading to a cascade of issues that impact data quality, project timelines, and overall business operations. The sourcing of data from new systems is fraught with errors and typos, and is a time-consuming process, which collectively contributes to several critical issues.

First, traditional methods of sourcing data often result in inaccuracies and inconsistencies, leading to incorrect data being used in compliance-based projects and business reports. This compromises the reliability of the data and can have far-reaching implications for decision-making and regulatory compliance.

Additionally, traditional methods of data sourcing may introduce delays and uncertainties in project timelines. This is particularly detrimental to data pipeline projects, where data consistency is paramount. Frequent back-and-forth communication with Chief Data Officers (CDOs) to resolve data issues further exacerbates these delays.

Moreover, inaccurate data and delayed timelines can significantly impact business operations, leading to suboptimal decision-making and missed opportunities. Inconsistency in data streams hampers the ability to generate reliable business reports, affecting strategic planning and operational efficiency. Traditional methods of data sourcing may also delay the auditing process and increase the risk of non-compliance.

Also, traditional methods lack an automated verification process, which means that data governance policies are harder to enforce, leading to potential compliance issues and increased scrutiny during audits. Furthermore, each of these issues leads to higher costs associated with resource allocation and cluster usage for regression testing. The inefficiencies introduced by these traditional methods necessitate additional resources to ensure data accuracy, which drives up operational costs.

Accordingly, there is a need for a tool to address each of these challenges by enhancing the data integration process to ensure precise matching of data and column names across various sources and highlight discrepancies for swift resolution. Thus, there is the need for a system and method that enhances data quality, ensures consistency, and significantly reduces the time and resources required for data management.

### SUMMARY

The present disclosure, through one or more of its various aspects, embodiments, and/or specific features or sub-components, provides, inter alia, various systems, servers, devices, methods, media, programs, and platforms for comparing source data with user-required fields and columns to perform precise matching of data and column names to migrate data into a predetermined format. According to an aspect of the present disclosure, a method for performing data migration is provided. The method may be implemented by at least one processor. The method may include: receiving, by the at least one processor, a user prompt and an upload file; selecting, by the at least one processor, a core processing unit from among a plurality of processing models; converting, by the at least one processor via a data parser, the upload file into first metadata having a file format based on the user prompt; identifying, by the at least one processor, schema information from the first metadata; storing, by the at least one processor, the schema information in a metadata hub; aligning, by the at least one processor via the core processing unit, the schema information into a tabular format based on the user prompt; analyzing, by the at least one processor via the core processing unit, the aligned schema information to identify whether at least one from among a missing field and a duplicated field exist; and generating, by the at least one processor, an output including the aligned schema information and a result of the analyzing.

The user prompt may include a core processing unit selection prompt for the selecting of the core processing unit, and the converting of the upload file may be based on a result of the selecting of the core processing unit.

The upload file may include a source file and a target file, and the schema information may include source file schema information and target file schema information.

The analyzing of the aligned schema information may include comparing each respective field of the source file schema information with each respective field of the target file schema information.

Each respective data name and each respective column name of the source file schema information may be aligned to match each respective data name and each respective column name of the target file schema information.

The plurality of processing models may include a Fuzzy Wuzzy model, an external machine learning (ML) model, and a small language model (SLM).

The method may further include: when the selected core processing unit includes at least one from among the Fuzzy Wuzzy model and the external ML model, anonymizing, by the at least one processor, the schema information, prior to the analyzing, wherein the anonymizing includes filtering highly confidential data (HCD) and personally identifiable information (PII); and transmitting, by the at least one processor, a result of the analyzing to a large language model (LLM) for further analysis.

The method may further include storing, by the at least one processor via the metadata hub, raw data from the upload file. The analyzing of the aligned schema information may be based on the raw data.

According to another aspect of the present disclosure, a computing apparatus for performing data migration is provided. The computing apparatus may include a processor; a memory; and a communication interface coupled to each of the processor, and the memory. The processor may be configured to: receive a user prompt and an upload file; select a core processing unit from among a plurality of processing models; convert, via a data parser, the upload file into first metadata having a file format based on the user prompt; identify schema information from the first metadata; store the schema information in a metadata hub; align, via the core processing unit, the schema information into a tabular format based on the user prompt; analyze, via the core processing unit, the aligned schema information to identify whether at least one from among a missing field and a duplicated field exist; and generate an output including the aligned schema information and a result of the analysis.

The user prompt may include a core processing unit selection prompt for the selection of the core processing unit. The conversion of the upload file may be based on a result of the selection of the core processing unit.

The upload file may include a source file and a target file. The schema information may include source file schema information and target file schema information.

The analysis of the aligned schema information may include comparing each respective field of the source file schema information with each respective field of the target file schema information.

Each respective data name and each respective column name of the source file schema information may be aligned to match each respective data name and each respective column name of the target file schema information.

The plurality of processing models may include a Fuzzy Wuzzy model, an external machine learning (ML) model, and a small language model (SLM).

The processor may be further configured to: when the selected core processing unit includes at least one from among the Fuzzy Wuzzy model and the external ML model, anonymize the schema information, prior to the analysis, wherein the anonymizing includes filtering highly confidential data (HCD) and personally identifiable information (PII); and transmit a result of the analysis to a large language model (LLM) for further analysis.

The processor may be further configured to: store, via the metadata hub, raw data from the upload file. The analysis of the aligned schema information may be based on the raw data.

According to yet another aspect of the present disclosure, a non-transitory computer readable storage medium storing instructions for performing data migration is provided. The storage medium includes executable code which, when executed by a processor, may cause the processor to: receive a user prompt and an upload file; select a core processing unit from among a plurality of processing models; convert, via a data parser, the upload file into first metadata having a file format based on the user prompt; identify schema information from the first metadata; store the schema information in a metadata hub; align, via the core processing unit, the schema information into a tabular format based on the user prompt; analyze, via the core processing unit, the aligned schema information to identify whether at least one from among a missing field and a duplicated field exist; and generate an output including the aligned schema information and a result of the analysis.

The user prompt may include a core processing unit selection prompt for the selection of the core processing unit. The conversion of the upload file may be based on a result of the selection of the core processing unit.

The upload file may include a source file and a target file. The schema information may include source file schema information and target file schema information.

The analysis of the aligned schema information may include comparing each respective field of the source file schema information with each respective field of the target file schema information.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for comparing source data with user-required fields and columns to perform precise matching of data and column names to migrate data into a predetermined format, according to an embodiment.

FIG. 2 illustrates a diagram of a network environment for comparing source data with user-required fields and columns to perform precise matching of data and column names to migrate data into a predetermined format, according to an embodiment.

FIG. 3 illustrates a system diagram of a system for comparing source data with user-required fields and columns to perform precise matching of data and column names to migrate data into a predetermined format, according to an embodiment.

FIG. 4 illustrates a process diagram of a process for comparing source data with user-required fields and columns to perform precise matching of data and column names to migrate data into a predetermined format, according to an embodiment.

FIG. 5 illustrates a flow diagram for comparing source data with user-required fields and columns to perform precise matching of data and column names to migrate data into a predetermined format, according to an embodiment.

FIG. 6 illustrates a first scenario flow diagram for comparing source data with user-required fields and columns to perform precise matching of data and column names to migrate data into a predetermined format, according to an embodiment.

FIG. 7 illustrates a second scenario flow diagram for comparing source data with user-required fields and columns to perform precise matching of data and column names to migrate data into a predetermined format, according to an embodiment.

FIG. 8 illustrates a third scenario flow diagram for comparing source data with user-required fields and columns to perform precise matching of data and column names to migrate data into a predetermined format, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

A system or method disclosed herein performs data migration between various data formats. Particularly, the system receives a file that contains data to be migrated. The system also displays a user prompt and receives user inputs based on that user prompt, which instruct the system on the migration destination and the destination file format. The system then selects an appropriate processing model and converts the received file into metadata having a format that is based on the received user prompt. The system then identifies schema information from the first metadata and stores the schema information in a metadata hub repository. Next, the system aligns the schema information into a predetermined tabular format and then analyzes the aligned schema information to determine if any fields have been duplicated and/or are missing. Then, the system generates an output that includes the aligned schema information and the results from the analysis.

The system enhances the data integration process by ensuring precise matching of data and column names across various sources, including databases, Kafka streams, comma-separated values (CSV), JavaScript Object Notation (JSON), Extensible Markup Language (XML), and more. It also automates the extraction of data from new sources, aligning it with existing user requirements. This significantly reduces errors and ensures data accuracy. Additionally, this system compares fields with actual data, identifying any missing or duplicated columns. If a field is missing, the system provides a prompt notification, ensuring swift resolution and maintaining data integrity. The system also ensures compliance with regulatory requirements by maintaining high standards of data quality. The system’s ability to highlight discrepancies and provide notifications helps prevent compliance issues and ensures data consistency. Moreover, the system is highly customizable and configurable, such that it is capable of working independently with any connector. This flexibility allows the system to seamlessly integrate with various data sources and systems, enhancing its utility across different environments. By streamlining data integration, the system optimizes operational efficiency, reduces the oversight burden on CDOs, and ensures that data governance policies are effectively enforced. Additionally, the system provides a technical improvement by integrating into existing data systems to align and analyze the accuracy of data migration in real-time, identify potential errors, and perform corrective actions necessary to correct these errors. Thus, the system provides various organizations and data systems with the ability to migrate data in an efficient and accurate manner.

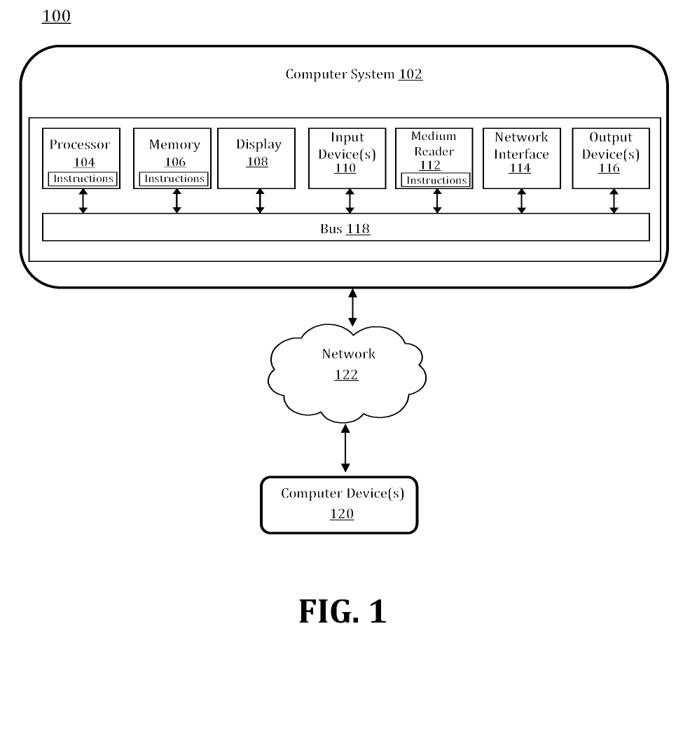

FIG. 1 is a system 100 for comparing source data with user-required fields and columns to perform precise matching of data and column names to migrate data into a predetermined format, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120, as shown in FIG. 1, may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the data migration module implemented by the system 100 may allow for comparing source data with user-required fields and columns to perform precise matching of data and column names to migrate data into a predetermined format. The configuration or data files, in some embodiments, may be written using JSON, but the disclosure is not limited thereto. For example, the configuration or data files may easily be extended to other readable file formats such as XML, Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

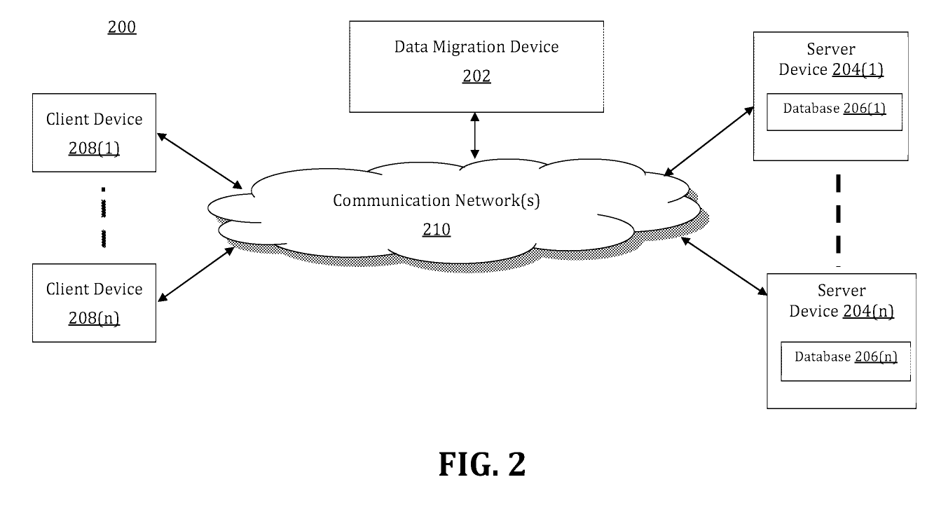

Referring to FIG. 2, a schematic of a network environment 200 for comparing source data with user-required fields and columns to perform precise matching of data and column names to migrate data into a predetermined format is illustrated.

In some embodiments, the above-described problems associated with conventional tools may be overcome by implementing a data migration device 202 as illustrated in FIG. 2 that may be configured for comparing source data with user-required fields and columns to perform precise matching of data and column names to migrate data into a predetermined format, but the disclosure is not limited thereto.

The data migration device 202 may include one or more computer systems 102, as described with respect to FIG. 1, which in aggregate provide the necessary functions.

The data migration device 202 may store one or more applications that can include executable instructions that, when executed by the data migration device 202, cause the data migration device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the data migration device 202 itself, may be located in virtual server(s) running in a cloud-based computing environment rather than being tied to one or more specific physical network computing devices. Also, the application(s) may be running in one or more virtual machines (VMs) executing on the data migration device 202. Additionally, in one or more embodiments of this technology, virtual machine(s) running on the data migration device 202 may be managed or supervised by a hypervisor.

In the network environment 200 of FIG. 2, the data migration device 202 may be coupled to a plurality of server devices 204(1)-204(n) that hosts a plurality of databases 206(1)-206(n), and also to a plurality of client devices 208(1)-208(n) via communication network(s) 210. A communication interface of the data migration device 202, such as the network interface 114 of the computer system 102 of FIG. 1, operatively couples and communicates between the data migration device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the data migration device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The data migration device 202 may be a standalone device or integrated with one or more other devices or apparatuses, such as one or more of the server devices 204(1)-204(n), for example. In one example, the data migration device 202 may be hosted by one of the server devices 204(1)-204(n), and other arrangements are also possible. Moreover, one or more of the devices of the data migration device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the data migration device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) host the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the data migration device 202 that may efficiently provide a platform for comparing source data with user-required fields and columns to perform precise matching of data and column names to migrate data into a predetermined format, but the disclosure is not limited thereto.

The client devices 208(1)-208(n) may run interface applications, such as standard web browsers or standalone client applications, which may provide an interface to communicate with the data migration device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the data migration device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the data migration device 202, the server devices 204(1)-204(n), or the client devices 208(1)-208(n), for example, may be configured to operate as virtual instances on the same physical machine. For example, one or more of the data migration devices 202, the server devices 204(1)-204(n), or the client devices 208(1)-208(n) may operate on the same physical device rather than as separate devices communicating through communication network(s) 210. Additionally, there may be more or fewer data migration devices 202, server devices 204(1)-204(n), or client devices 208(1)-208(n) than illustrated in FIG. 2. In some embodiments, the data migration device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

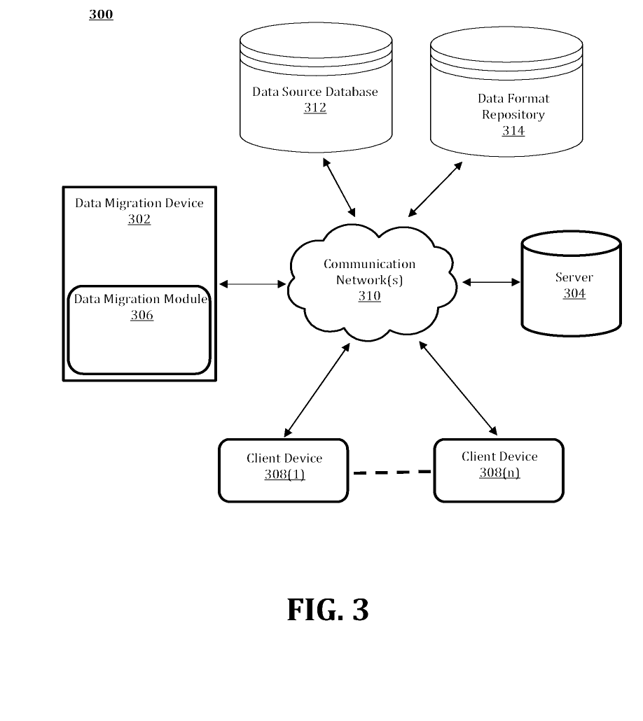

FIG. 3 illustrates a system diagram for comparing source data with user-required fields and columns to perform precise matching of data and column names to migrate data into a predetermined format, in accordance with an embodiment.

As illustrated in FIG. 3, the system 300 may include a data migration device 302 within which a data migration module 306 is embedded, a server 304, a data source database 312, a data format repository 314, a plurality of client devices 308(1) … 308(n), and a communication network 310.

In some embodiments, the data migration device 302 including the data migration module 306 may be connected to the server 304, the data source database 312, and the data format repository 314 via the communication network 310. The data migration device 302 may also be connected to the plurality of client devices 308(1) … 308(n) via the communication network 310, but the disclosure is not limited thereto. The data source database 312 and the data format repository 314 may include one or more repositories or databases.

In an embodiment, the data migration device 302 is described and shown in FIG. 3 as including the data migration module 306, although it may include other rules, policies, modules, databases, or applications, for example. In some embodiments, the data source database 312 and the data format repository 314 may be configured to store ready to use modules written for each Application Programming Interface (API) for all environments. Although only one database is illustrated in FIG. 3, the disclosure is not limited thereto. Any number of desired databases and/or repositories may be utilized for use in the disclosed invention herein. The data source database 312 and the data format repository 314 may be a mainframe database, a log database that may produce programming for searching, monitoring, and analyzing machine-generated data via a web interface, but the disclosure is not limited thereto. In addition, the data source database 312 and the data format repository 314 may store a plurality of data and tabular formats for performing data migration.

In some embodiments, the data migration module 306 may be configured to receive real-time feed of data from the plurality of client devices 308(1) … 308(n) and secondary sources via the communication network 310.

The data migration module 306 may be configured to: receive a user prompt and an upload file; select a core processing unit from among a plurality of processing models; convert, via a data parser, the upload file into first metadata having a file format based on the user prompt; identify schema information from the first metadata; store the schema information in a metadata hub; align, via the core processing unit, the schema information into a tabular format based on the user prompt; analyze, via the core processing unit, the aligned schema information to identify whether at least one from among a missing field and a duplicated field exist; and generate an output including the aligned schema information and a result of the analyzing.

The plurality of client devices 308(1) … 308(n) are illustrated as being in communication with the data migration device 302. In this regard, the plurality of client devices 308(1) … 308(n) may be “clients” (e.g., customers) of the data migration device 302 and are described herein as such. Nevertheless, it is to be known and understood that the plurality of client devices 308(1) … 308(n) need not necessarily be “clients” of the data migration device 302, or any entity described in association therewith herein. Any additional or alternative relationship may exist between either or both plurality of client devices 308(1) … 308(n) and the data migration device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) … 308(n) may communicate with the data migration device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The data migration device 302 may be the same or similar to the data migration device 202 as described with respect to FIG. 2, including any features or combination of features described with respect thereto.

Upon being started, the data migration device 302 executes a process for comparing source data with user-required fields and columns to perform precise matching of data and column names to migrate data into a predetermined format.

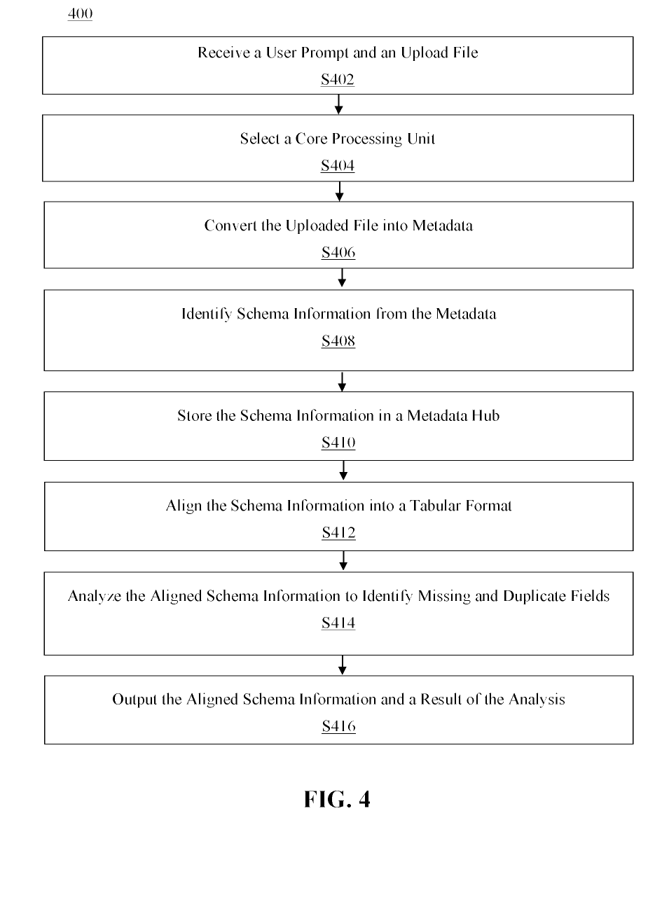

FIG. 4 illustrates a process 400 for comparing source data with user-required fields and columns to perform precise matching of data and column names to migrate data into a predetermined format, according to an embodiment.

In process 400 of FIG. 4, at step S402, the data migration device 302 may receive a user prompt and an uploaded file. In some embodiments, the uploaded file may contain a plurality of data that may be related to a particular source (e.g., databases, Kafka streams, Mercury s3, AWS, etc.) or industry (e.g., banking, asset, and wealth management, etc.). The uploaded file may contain source data that is collected from various approved data sources (ADS) and/or source of records (SOR) where the data may be generated and validated for distribution. The SOR and/or ADS may provide raw data that may be used for processing and analysis. In some embodiment, data sets from the uploaded file may be registered as being associated with recognized data entities (e.g., Account, Trades, Instruments, Positions, etc.). The uploaded file may be in a variety of diverse file formats (e.g., CSV, JSON, XML, Parquet, Avro, Optimized Row Columnar (ORC), Kafka, Iceberg, etc.). In some embodiments, the uploaded file may include a source file and a target file. The source file may correspond to the file containing the data to be migrated and the target file may correspond to the destination file for which the data is to be migrated to. In an embodiment, the user prompt may include a mechanism or selection prompt for selecting the destination (i.e., target) file and format. The user prompt may also include a mechanism or selection prompt for selecting the core processing unit.

At step S404, the data migration device 302 may select a core processing unit. The core processing unit may be selected from among a plurality of different processing models. In an embodiment, the type of core processing unit may be selected based on a core processing unit selection prompt as part of the user prompt. In some embodiments, the core processing unit may be a Fuzzy Wuzzy model that uses a string-matching algorithm for data comparison. In an embodiment, the core processing unit may be an ML clustering supervised model that utilizes trained models based on Random Forest and K-Nearest Neighbors (KNN) for data clustering. The ML clustering supervised model may be applied to the datasets of the uploaded file to generate a comparison with the destination file labels and to determine the accuracy of the matching of the source file labels with the destination file labels.

In some embodiments, the core processing unit may be an SLM that is an in-house transformer architecture focused for the terms of the selected industry or source in which the data migration is being applied. The in-house transformer architecture of the SLM may also be trained on a column dictionary and data from a metadata hub. The training may use a reduced number of defined parameters. Therefore, the SLM may be designed to analyze data without relying on external artificial intelligence (AI) or ML services, ensuring data privacy and protection of PII. The SLM may implement a custom encoder/decoder, a sequence-to-sequence data generator, a vector storage for the created weighted embeddings, a querying ability via a scalable search engine, and a masked language model, in order to predict missing data. The SLM may provide a comprehensive solution for schema generation, as well as metadata management and analysis, ensuring the confidentiality of highly sensitive data and offering flexible processing options that are tailored to user needs.

At step S406, the data migration device 302 may convert the uploaded file into metadata. In an embodiment, the uploaded file may be converted to metadata via a data parser. The data parser may be a parser program with the ability to convert various file formats (e.g., Avro, Parquet ,CSV ,Fixed Length , JSON, XML, Iceberg, etc.) into a predetermined file format (e.g., Python Pandas Dataframe, PySpark Dataframe, etc.). The predetermined file format may be based on an engine algorithm selected at the user prompt. The data migration device 302 may also convert the uploaded file into sample data having the predetermined file format. In an embodiment, the metadata of the file and the sample data may be compared by the core processing unit. The results may be transmitted to an agent. The agent may be at least one AI agent and may function as a smart router that determines the phase of data processing and analyzes the interactions with internal APIs and external APIs. In some embodiment, the uploaded file may include a source file and a target file. Both the source file and the target file may be converted to respective metadata and respective sample data.

In an embodiment, the data migration device 302 may include a model context protocol (MCP) that may act as a universal bridge between all AI agents associated with the data migration device 302. Additionally, the MCP may help integrate the data migration device 302 and/or the AI agents with an LLM, SLM, or any external model associated with the data migration device 302. Accordingly, the MCP helps create a centralized platform for data integration efforts by intelligently coordinating various models and AI agents.

At step S408, the data migration device 302 may identify schema information from the converted metadata. The schema information may relate to specific terms, labels, and/or identifiers for transferring into the destination file format. For example, the schema information may relate to specific labels for migrating data into a tabular format of the destination file. In an embodiment, the schema information may include source file schema information and target file schema information.

Next, at step S410, the data migration device 302 may store the schema information in a metadata hub. The metadata hub may act as a central repository for schema information collected from the source data, enabling efficient metadata management and retrieval. The metadata hub may also keep sample data as a copy for reference and comparison purposes. Thus, the metadata hub may act as a datastore. The metadata hub may have an internal scheduler, which runs data exploration on the ADS, the SORs, the schema identification for the registered datasets, and every successful run of the data migration device 302 with a defined dataset. In an embodiment, the data migration device 302 may also store raw data, from the uploaded file, in the metadata hub.

At step S412, the data migration device 302 may align the identified schema information into a tabular format that is based on the user prompt. The selected core processing unit may do the aligning. The core processing unit may integrate various algorithms and models to analyze the metadata and perform the alignment.

Next, at step S414, the data migration device 302 may analyze the aligned schema information. The data migration device 302 may determine whether there is a field missing in the aligned tabular format. The data migration device 302 may also determine if duplicate fields were created or exist in the aligned tabular format. In some embodiments, the analyzing of the aligned schema information may include comparing each respective field of the source file schema information with each respective field of the target file schema information. In an embodiment, the analyzing of the aligned schema information may also be based on the raw data from the uploaded file that is stored in the metadata hub. For example, the raw data may be analyzed to determine if all the appropriate information is migrated in the aligned format and if information has been duplicated or deleted. In some embodiments, when the data is further analyzed by an external LLM, the data migration device 302 may anonymize the metadata and/or schema information prior to its analysis. The anonymization of the metadata and/or schema information may include filtering or removing HCD and PII contained within the metadata. Additionally, HCD and PII may be replaced with anonymous or non-identifiable information.

Then, at step S416, the data migration device 302 may output the aligned schema information and the result of the analysis. For example, the aligned schema information may be output in a tabular format that is provided within the target/destination file. In an embodiment, the data migration device 302 may generate reports and schemas that can be downloaded or sent to relevant teams, departments, or users for further analysis and decision-making. The output may be generated as an email or as a display on a user interface. In some embodiments, the output may be generated as an extract, transform, and load (ETL) code to load to a cloud object storage (e.g., AWS S3).

The data migration device 302 including the core processing unit improves existing technology and enhances data privacy. For example, the data migration device 302 may use an in-house model like SLM to ensure that sensitive data is not exposed to external AI services. Additionally, the data migration device 302 improves flexibility and adaptability of the underlying technology by allowing users to choose from multiple algorithms and models based on their specific requirements, thus enhancing the system's adaptability. Moreover, the data migration device 302 improves the efficiency of the technology through the integration of smart routing and advanced processing models that streamline data analysis and reduce time and resource consumption.

The data migration device 302 enhances the data integration process by ensuring precise matching of data and column names across various sources and highlighting discrepancies for swift resolution. The data migration device 302 also enhances data quality, ensures consistency, and significantly reduces the time and resources required for data management. This allows data teams to focus on strategic initiatives, improve overall operational efficiency, and reduce the burden on CDOs. The data migration device 302 also automates the extraction of data from new sources, aligning it with existing user requirements. Moreover, the data migration device 302 compares fields with actual data, identifying any missing or duplicated columns. If a field is missing, it promptly notifies the concerned team, ensuring swift resolution and maintaining data integrity.

Additionally, the data migration device 302 ensures compliance with regulatory requirements by maintaining high standards of data quality. Its ability to highlight discrepancies and notify relevant teams helps prevent compliance issues and ensures data consistency. The data migration device 302 is highly customizable and configurable, such that it is capable of working independently with any connector. This flexibility allows it to seamlessly integrate with various data sources and systems, enhancing its utility across different environments. By streamlining data integration, the data migration device 302 optimizes operational efficiency. This reduces the oversight burden on CDOs and ensures that data governance policies are effectively enforced. Moreover, the data migration device 302 may be integrated with any cloud options if the source of data resides in cloud data sources.

The data migration device 302 may generate a schema that displays the similarity of data and includes a download option, highlighting any missing fields from the source. The data migration device 302 provides a unified platform that brings a host of new benefits, significantly enhancing data management processes and operational efficiency. The data migration device 302 consolidates data integration efforts into one platform, eliminating the need to invest in multiple products and workstreams. This reduces complexity and workload among teams, making data management more manageable and efficient. The data migration device 302 may also reduce costs. Unlike traditional infrastructures that incur high annual license and maintenance costs, the data migration device 302 may be an open-source tool. This in-house solution significantly reduces the total cost of ownership.

The data migration device 302 is also customizable and scalable, as the rule engine (i.e., core processing unit) within the data migration device 302 offers full control over implementation due to its high customizability, without enforcing constraints. The data migration device 302 may enable faster time to market by allowing developers to focus solely on building solutions. The reusable framework can be applied across different lines of business, promoting harmonization of controls and reducing development time. The data migration device 302 follows a plugin model, making it easy to integrate with existing systems.

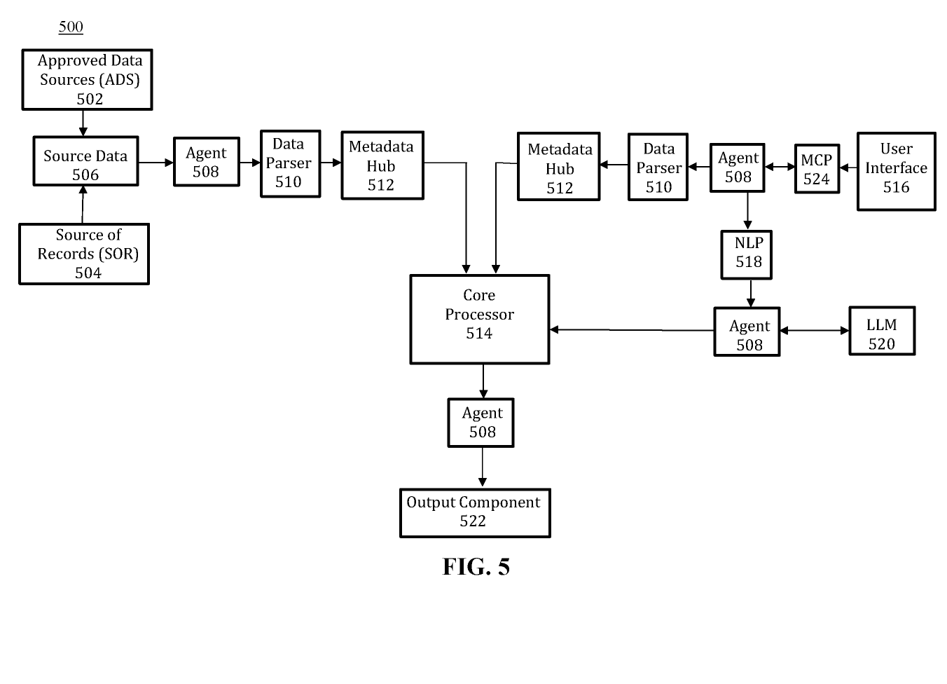

FIG. 5 illustrates a flow diagram 500 for comparing source data with user-required fields and columns to perform precise matching of data and column names to migrate data into a predetermined format, according to an embodiment.

FIG. 5 shows that the source data module 506 includes data received from an ADS 502 and an SOR 504. The ADS 502 and the SOR 504 may include a variety of platforms where data is generated and validated for distribution, and the raw data is provided for processing and analysis. The datasets may be registered as recognized data entities (e.g., Account, Trades, Instrument, Positions, etc.). The data then passes from the source data module 506 to an agent 508. The agent 508 may be at least one AI agent. The agent 508 may function as a smart router that determines the phase of data processing and analyzes the interactions with internal APIs and external APIs. The agent 508 may also facilitate metadata gathering and data parsing, ensuring that data is directed to the appropriate processing module. For example, the agent 508 may ensure that the data receives natural language interpretation before proceeding to the core processor 514, when natural language interpretation is required. The agent 508 may also have a custom data anonymizer to limit and filter any HCD or PII.

The data next passes to the data parser 510. The data parser 510 may be a parser program (e.g., Pythonic Parser) that has the ability to convert various file formats (e.g., Avro, Parquet, CSV, Fixed Length, JSON, XML, Iceberg, etc.) into a predetermined file format (e.g., Python Pandas Dataframe, PySpark Dataframe, etc.) based on the engine algorithm chosen in the initial prompt. The converted data then passes from the data parser 510 to the metadata hub 512. The metadata hub 512 may act as a central repository for schema information collected from the source data 506, enabling efficient metadata management and retrieval. The metadata hub 512 may also keep sample data as a copy for reference and easy comparison. Thus, the metadata hub 512 may act as a datastore. The metadata hub 512 may also have an internal scheduler which runs data exploration on the ADS 502, the SORs 504, the identified schema, the registered datasets, and every successful run of the core processor 514 with a defined dataset.

The processed metadata then passes from the metadata hub 512 to the core processor 514. The core processor 514 may integrate various algorithms and models to analyze the metadata. Users may choose from different processing options, including a Fuzzy Wuzzy, an ML Clustering Supervised Model, and an SLM. The analyzed metadata is then then transmitted from the core processor 514 back to the agent 508, which may further process and/or analyze the metadata before transmitting it to the output component 522. The output component 522 may generate reports and schemas that can be downloaded or sent to relevant teams and/or users for further analysis and decision-making.

Additionally, as shown in FIG. 5, data may originate from a user interface 516 and pass to an MCP server 524, an agent 508, a data parser 510, a metadata hub 512, the core processor 514, back to the agent 508, and then to the output component 522, as detailed above. The MCP server 524 may function as a universal bridge for AI agents, enabling seamless integration with data ingestion processes while validating and standardizing all incoming inputs. Additionally, the MCP server 524 may help integrate the agent 508 and the LLM 520. The MCP server 524 may enforce governance and access controls to ensure that only authorized and properly formatted data and requests are processed. The MCP server 524 may act as a scalable and secure gateway, such that it facilitates both automated data flows and interactive user actions to maintain compliance, security, and data integrity throughout the system.

As shown in FIG. 5, after data is transmitted to the MCP server 524 from the user interface 516, it is transmitted to the agent 508 and then may be transmitted to a natural language processing (NLP) engine 518. Additionally, communication between the MCP 524 and the agent 508 may be bidirectional to better facilitate forced orchestration within the system. The NLP engine 518 may be based in a particular programming language (e.g., Python). The NLP engine 518 may interpret user messages and break down the messages into agent specific messages for easy routing and engine processing. The NLP engine 518 may also generate feedback to improve accuracy on the ML and SLM. For example, a label to be used for the comparison at the core processor 514 is retrieved as a prompt when choosing Fuzzy Wuzzy, however, this prompt may not be provided for the ML and SLM options, and the NLP engine 518 may be used to base the label on the first 100-100000 rows of data. A unique label with one or more columns may be generated based on similar matching data from the metadata hub 512.

The data may then be transmitted from the NLP engine 518 back to the agent 508. The agent 508 may either process and analyze the data and transmit it straight to the core processor 514, or the agent 508 may transmit the data to an LLM prompt component 520. The LLM prompt component 520 may provide an interface for non-HCD users, allowing for advanced language model interactions. When data is transmitted to the LLM prompt component 520 it may first be anonymized, such that HCD and PII are removed or replaced, in order to maintain data privacy. The anonymized data may then be transmitted from the LLM prompt component 520 back to the agent 508 where it may be further analyzed and processed before being transmitted to the core processor 514. The integration with the LLM prompt component 520 may be optional. Particularly, when the core processor 514 is selected to be an SLM, it may not be necessary to transmit the data to the LLM prompt component 520.

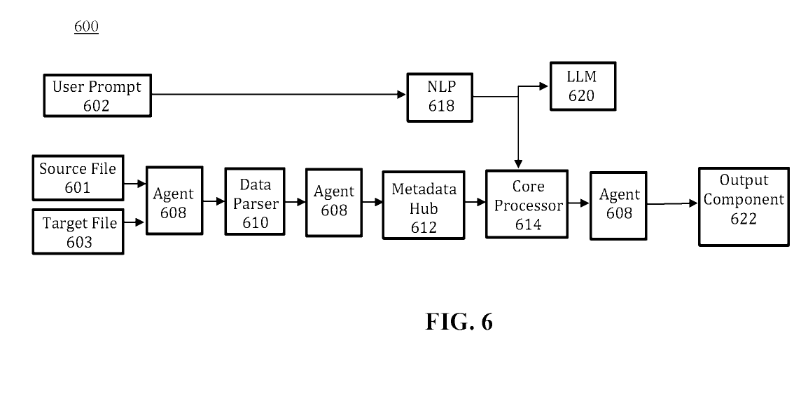

FIG. 6 illustrates a first scenario flow diagram 600 for comparing source data with user-required fields and columns to perform precise matching of data and column names to migrate data into a predetermined format, according to an embodiment.

FIG. 6 shows a flow diagram 600 for a first scenario, in which a user has two custom files, a source file 601 and a target file 603 that is meant to replace the source file 601. In this first scenario, there is also an option to use an LLM engine 620, if the core processor 614 is selected to be a Fuzzy Wuzzy or ML model, in order to improve accuracy. Initially, in this scenario, the user uploads a source file 601 and a target file 603. The user also identifies and/or selects the file types at the user prompt 602, but may provide little or no context to the content of the files. Next, the source file 601 and the target file 603 are transmitted to the agent 608, which transmits the files to the data parser 610. The agent 608 may be able to identify each phase of the first scenario diagram 600 and the result from each phase. The data parser 610 may have an engine in which data from both the source file 601 and the target file 603 are converted to metadata and sample data. The converted data may be in a particular format or structure (e.g., JSON). Additionally, the converted data may be saved as a copy and compared. The results are then returned back to the agent 608. In an embodiment, both the source file 601 and the target file 603 are run through the data parser 610 in parallel to save time. Then, the agent 608 investigates the results from the data parser 610, and if the results are determined to be successful, the agent 608 transmits the results to the metadata hub 612. The metadata hub 612 may store the metadata and sample data in a string vector format. The string vector format may be a dynamic array that stores multiple strings. This format allows the data to be processed and interpreted by the core processor 614.

Once the agent 608 investigates and verifies the results from the metadata hub 612, the agent 608 transmits the stored data to the core processor 614. After the core processor 614 receives the stored data, the NLP engine 618 provides guidance to the core processor 614 on which processing model to be used (e.g., Fuzzy Wuzzy, ML, or SLM). The guidance from the NLP engine is based on information received from the user prompt 602. When the Fuzzy Wuzzy model or the ML model is selected as the core processor 614, the core processor 614 may interact with an LLM engine 620 (e.g., OpenAI ChatGPT, Google Gemini, etc.) to improve the accuracy of the result. If interaction with the LLM engine 620 is requested, the HCD and/or PII are either removed or replaced with “xxx” and not used for the comparison. Next, the agent 608 investigates the results from running the data in the core processor 614 and generates the results in a text and table format in the target file 603. Then, the user may choose to email the result, generate a compare and match report, perform a schema comparison, and/or load the target file 603. Feedback may be obtained after each comparison to improve the comparison methods. For faster data retrieval an NLP generator (e.g., Spark SQL) may be used.

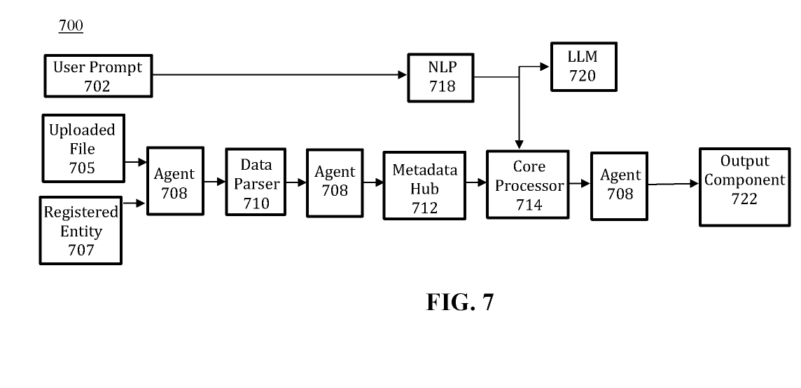

FIG. 7 illustrates a second scenario flow diagram 700 for comparing source data with user-required fields and columns to perform precise matching of data and column names to migrate data into a predetermined format, according to an embodiment.

FIG. 7 shows a flow diagram 700 for a second scenario, in which a user has an uploaded file 704, but would like to use a registered entity 707 instead of a new target file. In the second scenario, similar to the first scenario, there is an option to use an LLM 720, if the core processor 714 is selected to be a Fuzzy Wuzzy or ML model, in order to improve the accuracy.

In the second scenario, all the steps remain common with the first scenario, except that the data parser only runs once for the uploaded file 705, which is different than the first scenario where it ran twice (once for the source file 601 and then again for the target file 603). Similar to the first scenario, the second scenario contains a user prompt 702, an agent 708, a data parser 710, a metadata hub 712, a core processor 714, an NLP engine 718, an LLM engine 720, and an output component 722.

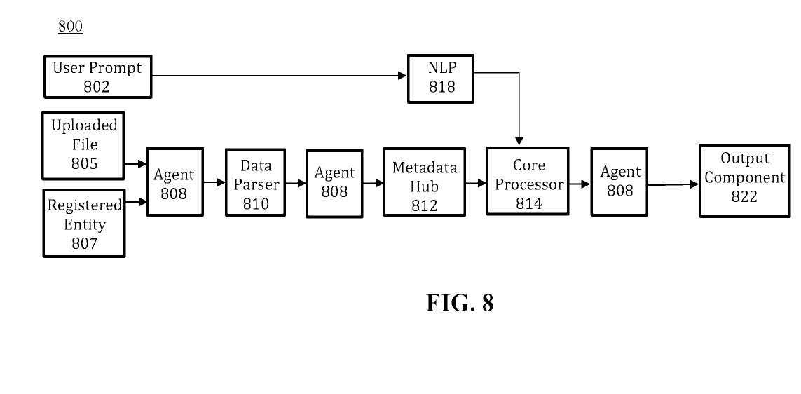

FIG. 8 illustrates a third scenario flow diagram 800 for comparing source data with user-required fields and columns to perform precise matching of data and column names to migrate data into a predetermined format, according to an embodiment.

FIG. 8 shows a flow diagram 800 for a third scenario, in which a user has an uploaded file 804 and would like to use a registered entity 807. However, in the third scenario, different from the first scenario and second scenario, the core processor 814 is selected to be a SLM model, in order to improve the accuracy and avoid any risks of data leak or an external provider making a copy of the data.

In the third scenario, all the steps remain common with the second scenario, except that there is no option for an LLM engine. Similar to the first and second scenarios, the third scenario contains a user prompt 802, an agent 808, a data parser 810, a metadata hub 812, a core processor 814, an NLP engine 818, and an output component 822.

Accordingly, with this technology, an optimized process for comparing source data with user-required fields and columns to perform precise matching of data and column names to migrate data into a predetermined format is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for performing data migration, the method being implemented by at least one processor, the method comprising:
receiving, by the at least one processor, a user prompt and an upload file;
selecting, by the at least one processor, a core processing unit from among a plurality of processing models;
converting, by the at least one processor via a data parser, the upload file into first metadata having a file format based on the user prompt;
identifying, by the at least one processor, schema information from the first metadata;
storing, by the at least one processor, the schema information in a metadata hub;
aligning, by the at least one processor via the core processing unit, the schema information into a tabular format based on the user prompt;
analyzing, by the at least one processor via the core processing unit, the aligned schema information to identify whether at least one from among a missing field and a duplicated field exist; and
generating, by the at least one processor, an output including the aligned schema information and a result of the analyzing.

2. The method of claim 1, wherein the user prompt includes a core processing unit selection prompt for the selecting of the core processing unit, and
wherein the converting of the upload file is based on a result of the selecting of the core processing unit.

3. The method of claim 1, wherein the upload file includes a source file and a target file, and wherein the schema information includes source file schema information and target file schema information.

4. The method of claim 3, wherein the analyzing of the aligned schema information includes comparing each respective field of the source file schema information with each respective field of the target file schema information.

5. The method of claim 4, wherein each respective data name and each respective column name of the source file schema information is aligned to match each respective data name and each respective column name of the target file schema information.

6. The method of claim 1, wherein the plurality of processing models includes a Fuzzy Wuzzy model, an external machine learning (ML) model, and a small language model (SLM).

7. The method of claim 6, further comprising:
when the selected core processing unit includes at least one from among the Fuzzy Wuzzy model and the external ML model, anonymizing, by the at least one processor, the schema information, prior to the analyzing, wherein the anonymizing includes filtering highly confidential data (HCD) and personally identifiable information (PII); and
transmitting, by the at least one processor, a result of the analyzing to a large language model (LLM) for further analysis.

8. The method of claim 1, further comprising:
storing, by the at least one processor via the metadata hub, raw data from the upload file,
wherein the analyzing of the aligned schema information is based on the raw data.

9. A computing apparatus for performing data migration, the computing apparatus comprising:
a processor;
a memory;
a display; and
a communication interface coupled to each of the processor, the memory, and the display,
wherein the processor is configured to:
receive a user prompt and an upload file;
select a core processing unit from among a plurality of processing models;
convert, via a data parser, the upload file into first metadata having a file format based on the user prompt;
identify schema information from the first metadata;
store the schema information in a metadata hub;
align, via the core processing unit, the schema information into a tabular format based on the user prompt;
analyze, via the core processing unit, the aligned schema information to identify whether at least one from among a missing field and a duplicated field exist; and
generate an output including the aligned schema information and a result of the analysis.

10. The computing apparatus of claim 9, wherein the user prompt includes a core processing unit selection prompt for the selection of the core processing unit, and
wherein the conversion of the upload file is based on a result of the selection of the core processing unit.

11. The computing apparatus of claim 9, wherein the upload file includes a source file and a target file, and wherein the schema information includes source file schema information and target file schema information.

12. The computing apparatus of claim 11, wherein the analysis of the aligned schema information includes comparing each respective field of the source file schema information with each respective field of the target file schema information.

13. The computing apparatus of claim 12, wherein each respective data name and each respective column name of the source file schema information is aligned to match each respective data name and each respective column name of the target file schema information.

14. The computing apparatus of claim 9, wherein the plurality of processing models includes a Fuzzy Wuzzy model, an external machine learning (ML) model, and a small language model (SLM).

15. The computing apparatus of claim 14, wherein the processor is further configured to:
when the selected core processing unit includes at least one from among the Fuzzy Wuzzy model and the external ML model, anonymize the schema information, prior to the analysis, wherein the anonymizing includes filtering highly confidential data (HCD) and personally identifiable information (PII); and
transmit a result of the analysis to a large language model (LLM) for further analysis.

16. The computing apparatus of claim 15, wherein the processor is further configured to:
store, via the metadata hub, raw data from the upload file,
wherein the analysis of the aligned schema information is based on the raw data.

17. A non-transitory computer readable storage medium storing instructions for performing data migration, the non-transitory computer readable storage medium comprising executable code which, when executed by a processor, causes the processor to:
receive a user prompt and an upload file;
select a core processing unit from among a plurality of processing models;
convert, via a data parser, the upload file into first metadata having a file format based on the user prompt;
identify schema information from the first metadata;
store the schema information in a metadata hub;
align, via the core processing unit, the schema information into a tabular format based on the user prompt;
analyze, via the core processing unit, the aligned schema information to identify whether at least one from among a missing field and a duplicated field exist; and
generate an output including the aligned schema information and a result of the analysis.

18. The non-transitory computer readable storage medium of claim 17, wherein the user prompt includes a core processing unit selection prompt for the selection of the core processing unit, and
wherein the conversion of the upload file is based on a result of the selection of the core processing unit.

19. The non-transitory computer readable storage medium of claim 17, wherein the upload file includes a source file and a target file, and wherein the schema information includes source file schema information and target file schema information.

20. The non-transitory computer readable storage medium of claim 19, wherein the analysis of the aligned schema information includes comparing each respective field of the source file schema information with each respective field of the target file schema information.
